(19) United States
(12) Patent Application Publication
(10) Pub. No.: US 2023/0173709 A1
(43) Pub. Date: Jun. 8, 2023

(54) LUMBER BOARD CUTTING APPARATUS HAVING LUMBER BOARD GRIPPER

(71) Applicant: Illinois Tool Works Inc., Glenview, IL (US)

(72) Inventors: Ronald E. Findley, Arlington, TX (US); Peter S. Walter, Frisco, TX (US); Alexandre S. Da Silva, Allen, TX (US)

(21) Appl. No.: 18/054,352

(22) Filed: Nov. 10, 2022

Related U.S. Application Data
(60) Provisional application No. 63/285,724, filed on Dec. 3, 2021.

(51) Int. Cl. B27B 31/00

(52) U.S. Cl. CPC B27B 31/003; B27B 5/36

(57) ABSTRACT

A lumber board cutting apparatus including a housing, an infeed drive, an outfeed drive, a lumber board cutter, and a lumber board gripper including a gripper arm, a lumber board mover connected to the gripper arm, and a lumber board clamper connected to the gripper arm.

### PRIORITY

This application claims priority to and the benefit of U.S. Provisional Patent Application No. 63/285,724, filed Dec. 3, 2021, the contents of which are incorporated herein by reference in their entirety.

### BACKGROUND

Various known lumber board cutting systems are configured to cut lumber boards into a variety of different lengths. Certain desired lengths of lumber boards can be relatively short (such as 6 to 12 inches long). Various known lumber board cutting systems can cut lumber boards of such relatively short lengths, but after cutting, certain short lengths of lumber boards drop onto a sort conveyor belt and the conveyor belt deposits the pieces into a bin, because these lumber board cutting systems do not have an efficient way to handle such short lengths of lumber board after they are cut. When such short lengths of lumber board drop into a bin, they can be mixed with scrap pieces of lumber board and must be sorted out by an operator. This is time consuming and inefficient. There is a need for lumber board cutting systems that are better able to handle short lengths of lumber board after they are cut.

### SUMMARY

Various embodiments of the present disclosure provide a lumber board cutting apparatus that better handles short lengths of lumber board after they are cut. In various embodiments of the present disclosure, the lumber board cutting apparatus includes a lumber board gripper configured to selectively grip a lumber board prior to the short length of lumber board being cut from a longer length of lumber board, and to move the cut short length of lumber board to an outfeed drive after the short length of lumber board has been cut.

Other objects, features, and advantages of the present disclosure will be apparent from the following detailed disclosure and accompanying drawings.

### BRIEF DESCRIPTION OF THE FIGURES

FIG. 1 is a front perspective view of a lumber board cutting apparatus of one example embodiment of the present disclosure and showing the lumber board gripper of this example embodiment of the present disclosure.

FIG. 2 is a perspective view of the lumber board gripper of FIG. 1 removed from the lumber board cutting apparatus of FIG. 1, and wherein the gripper arm of the lumber board gripper is shown in a fully retracted position and in a non-gripping position.

FIG. 3 is a top view of the lumber board gripper of FIGS. 1 and 2, wherein the gripper arm of the lumber board gripper is shown in the fully retracted position and in the non-gripping position.

FIG. 4 is an outer end view of the lumber board gripper of FIGS. 1 and 2, where the gripper arm of the lumber board gripper is shown in the fully retracted position and in the non-gripping position.

FIG. 5 is a bottom view of the lumber board gripper of FIGS. 1 and 2, wherein the gripper arm of the lumber board gripper is shown in the fully retracted position and in the non-gripping position.

FIG. 6 is a rear view of the lumber board gripper of FIGS. 1 and 2, wherein the gripper arm of the lumber board gripper is shown in the fully retracted position and in the non-gripping position.

FIG. 7 is a front view of the lumber board gripper of FIGS. 1 and 2, wherein the gripper arm of the lumber board gripper is shown in the retracted position and in the non-gripping position.

FIG. 8 is an inner end view of the lumber board gripper of FIGS. 1 and 2, wherein the gripper arm of the lumber board gripper is shown in the fully retracted position and in the non-gripping position.

FIG. 9 is bottom perspective view of the linear slide of the lumber board gripper of FIGS. 1 and 2.

FIGS. 10A, 10B, 10C, and 10D are inner end views of the lumber board gripper of FIGS. 1 and 2 and showing the various pivoting positions of the gripper arm during the process of moving from the non-gripping position to the gripping position and gripping a lumber board.

FIG. 11 is a fragmentary front perspective view of the lumber board cutting apparatus of FIG. 1, and the gripper arm of the lumber board gripper of FIG. 1 shown in the fully retracted position and in the non-gripping position.

FIG. 12 is a fragmentary front perspective view of the lumber board cutting apparatus of FIG. 1, and the gripper arm of the lumber board gripper of FIG. 1 shown in the fully extended position and in the non-gripping position.

FIG. 13 is a fragmentary front perspective view of the lumber board cutting apparatus of FIG. 1, and the gripper arm of the lumber board gripper of FIG. 1 shown in the fully extended position and in the gripping position.

FIG. 14 is a fragmentary front view of the lumber board cutting apparatus of FIG. 1, and the gripper arm of the lumber board gripper of FIG. 1 shown in the fully extended position and in the gripping position.

FIG. 15 is a fragmentary front view of the lumber board cutting apparatus of FIG. 1, and the gripper arm of the lumber board gripper of FIG. 1 shown in the fully retracted position and in the gripping position.

FIG. 16 is a fragmentary front perspective view of the lumber board cutting apparatus of FIG. 1, and the gripper arm of the lumber board gripper of FIG. 1 shown in the fully retracted position and in the gripping position.

FIG. 17 is a fragmentary front perspective view of the lumber board cutting apparatus of FIG. 1, and the gripper arm of the lumber board gripper of FIG. 1 shown in the fully retracted position and in the gripping position and gripping a lumber board.

### DETAILED DESCRIPTION

While the systems, devices, and methods described herein may be embodied in various forms, the drawings show, and the specification describes certain exemplary and non-limiting embodiments. Not all of the components shown in the drawings and described in the specification may be required, and certain implementations may include additional, different, or fewer components. Variations in the arrangement and type of the components; the shapes, sizes, and materials of the components; and the manners of connections of the components may be made without departing from the spirit or scope of the claims. Unless otherwise indicated, any directions referred to in the specification reflect the orientations of the components shown in the corresponding drawings and do not limit the scope of the present disclosure. Further, terms that refer to mounting methods, such as mounted, connected, etc., are not intended to be limited to direct mounting methods but should be interpreted broadly to include indirect and operably mounted, connected, and like mounting methods. This specification is intended to be taken as a whole and interpreted in accordance with the principles of the present disclosure and as understood by one of ordinary skill in the art.

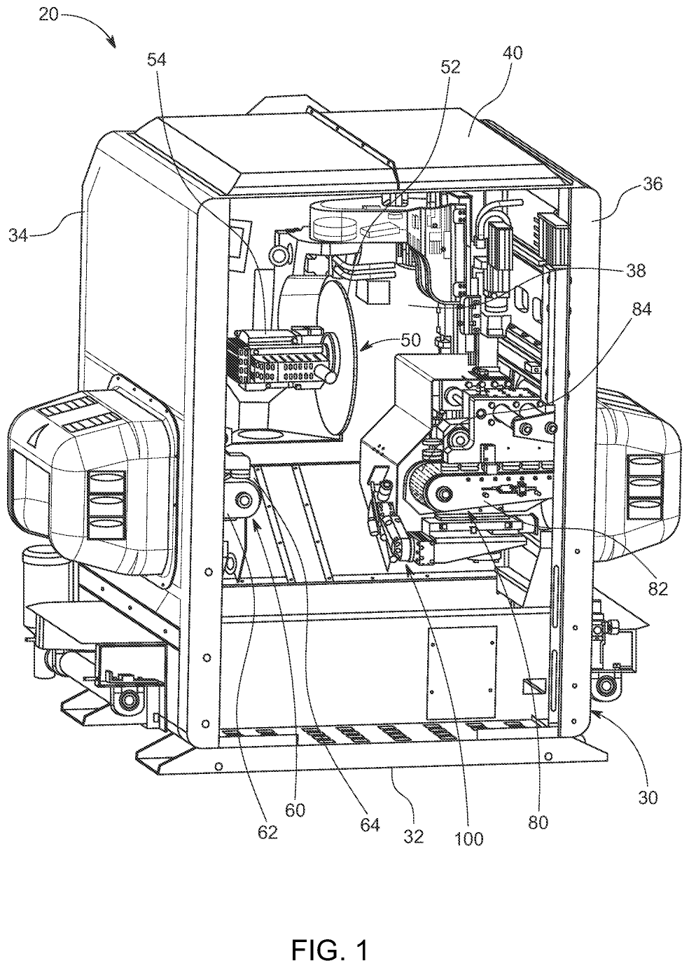

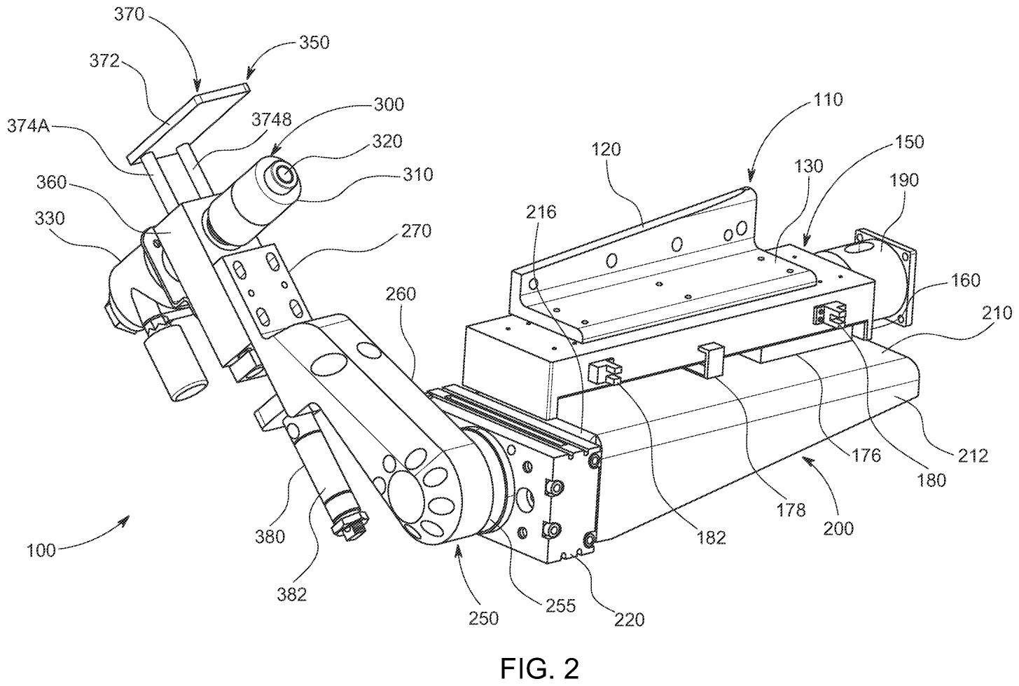

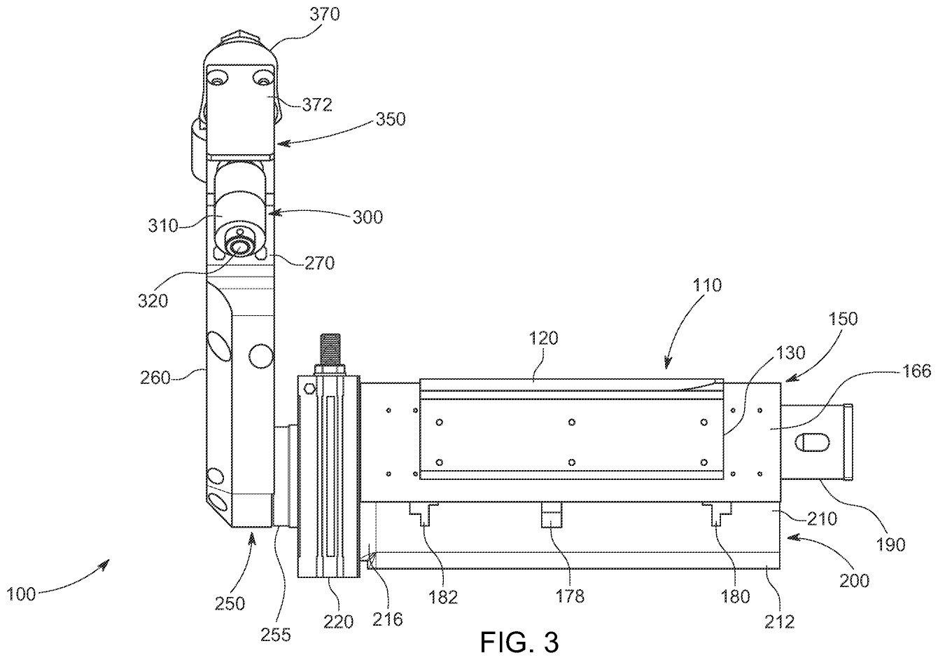

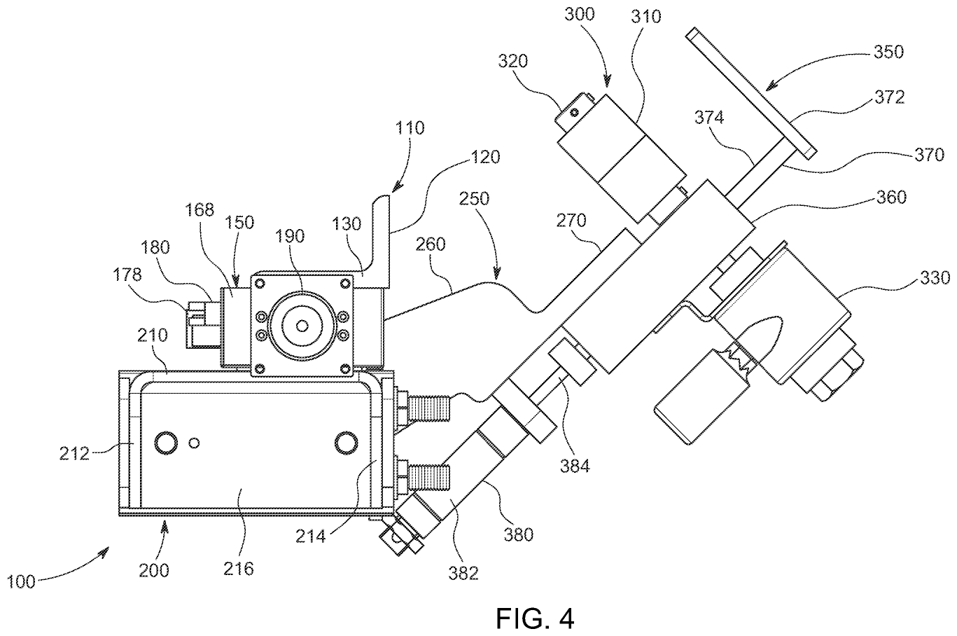

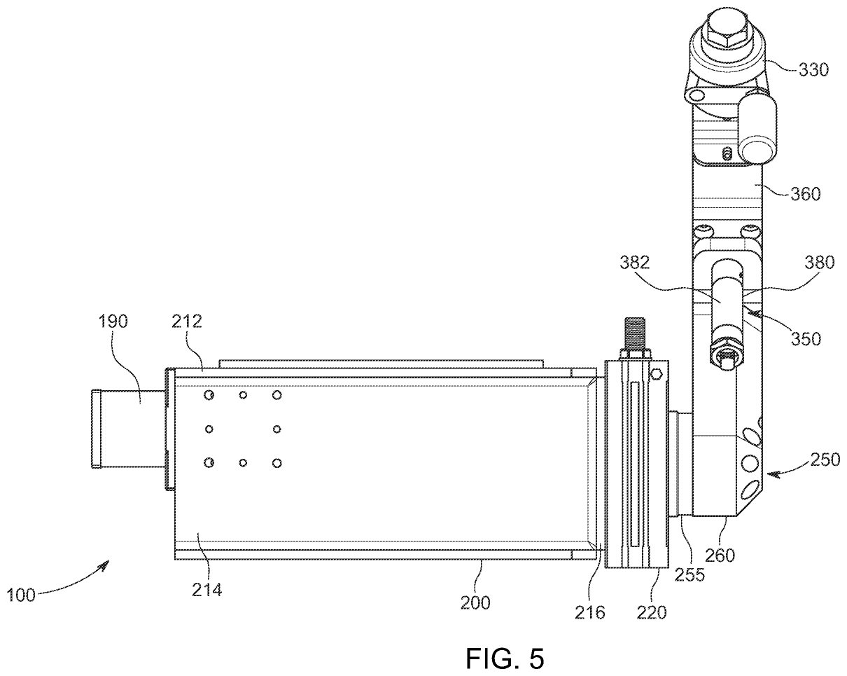

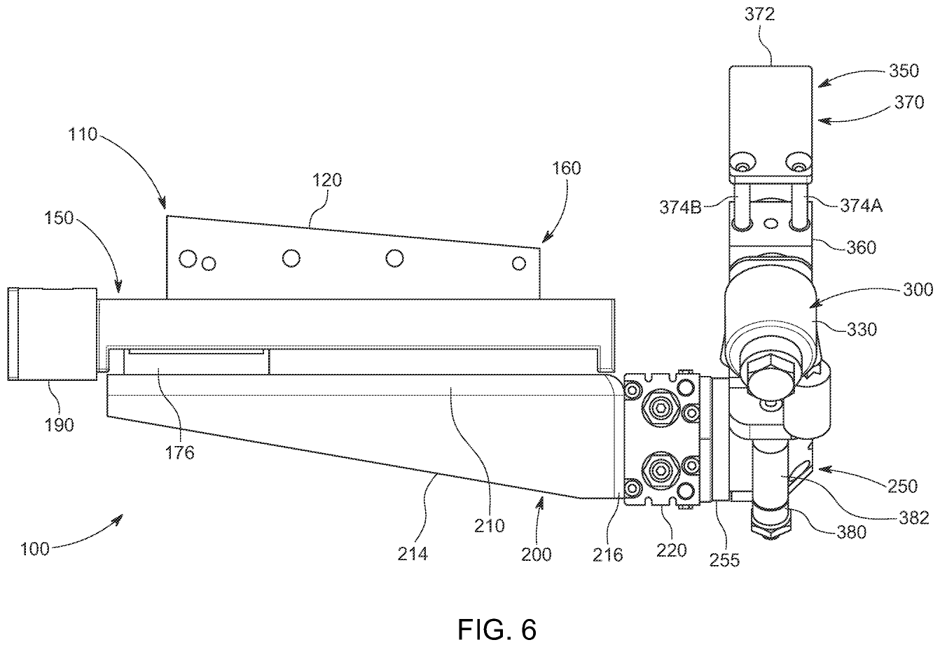

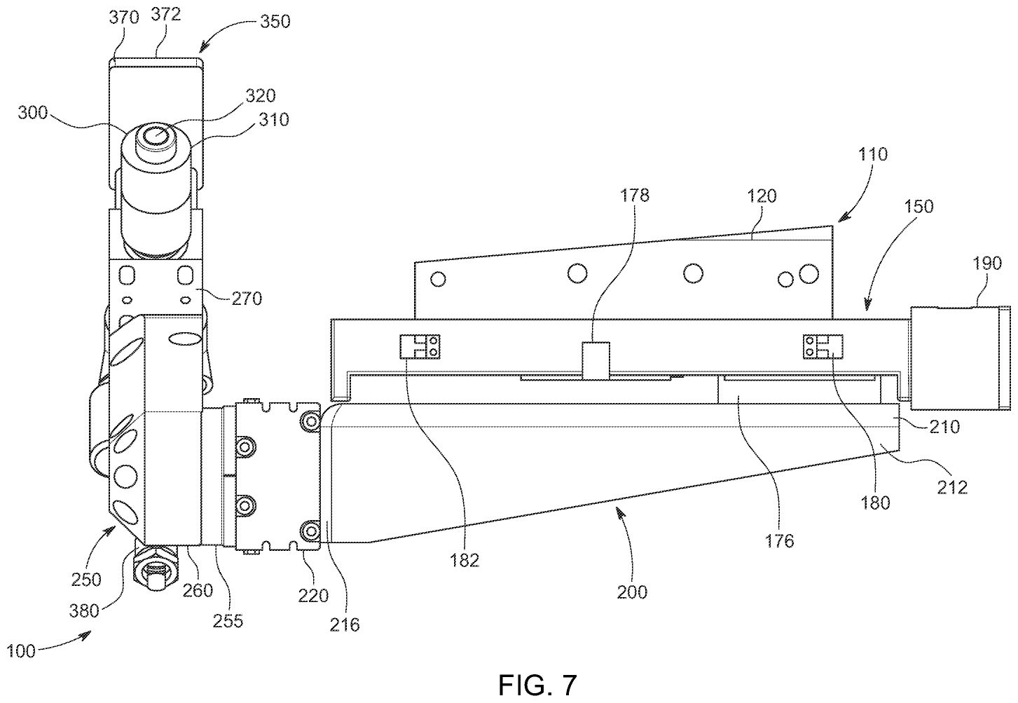

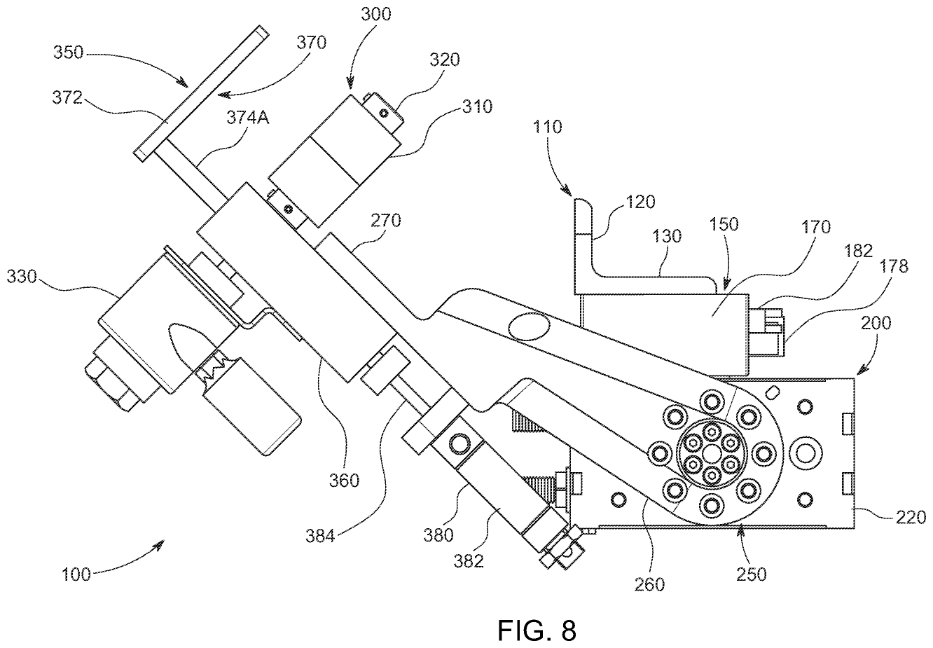

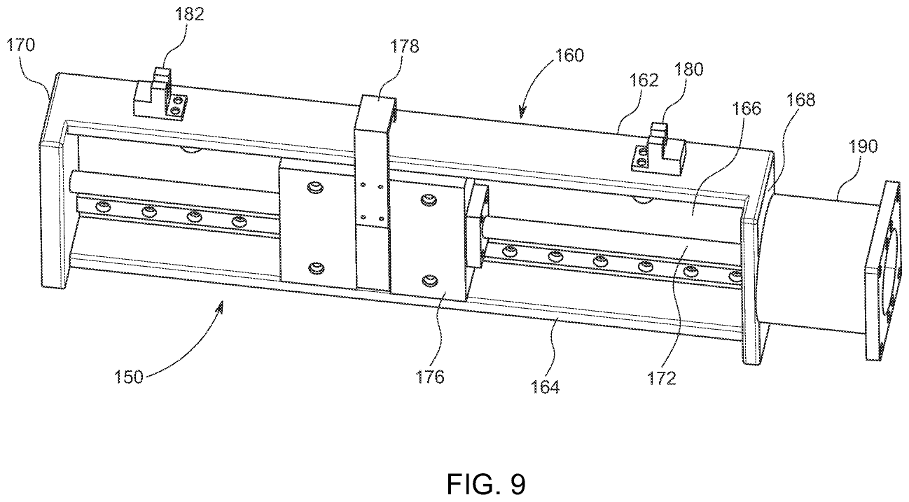

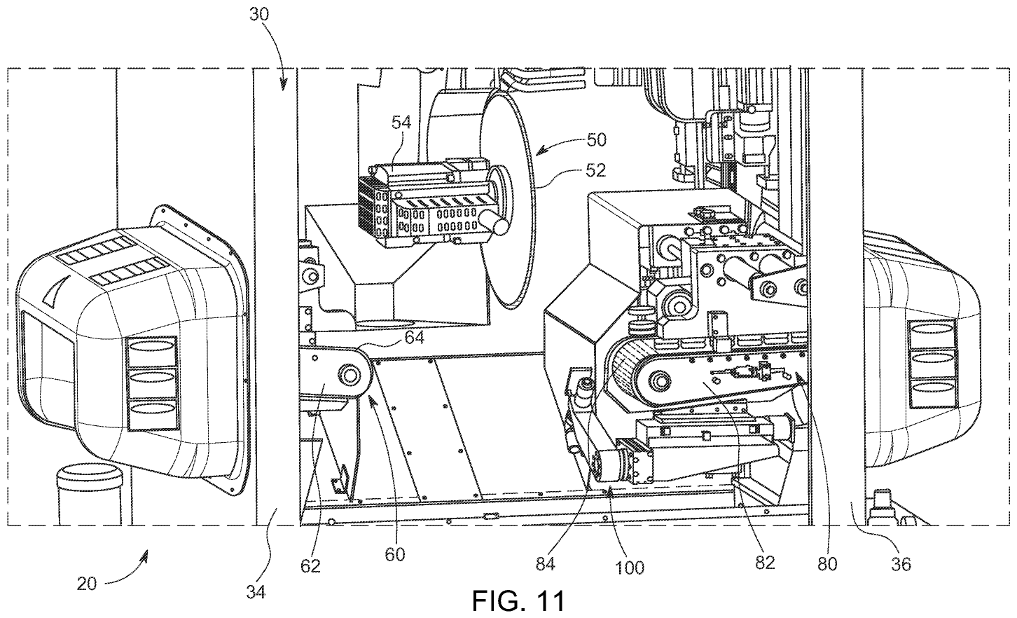

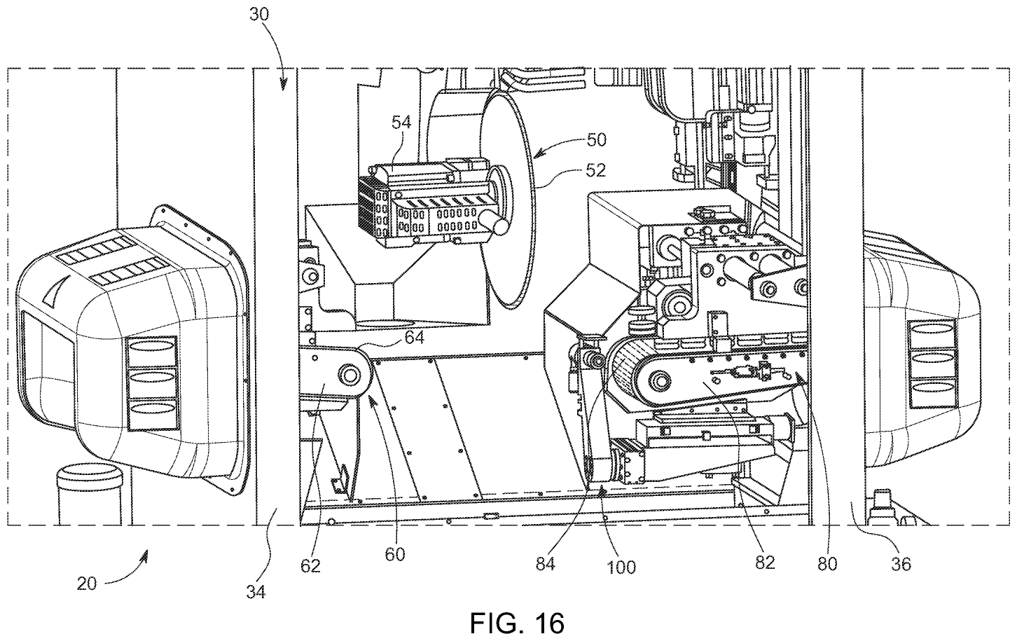

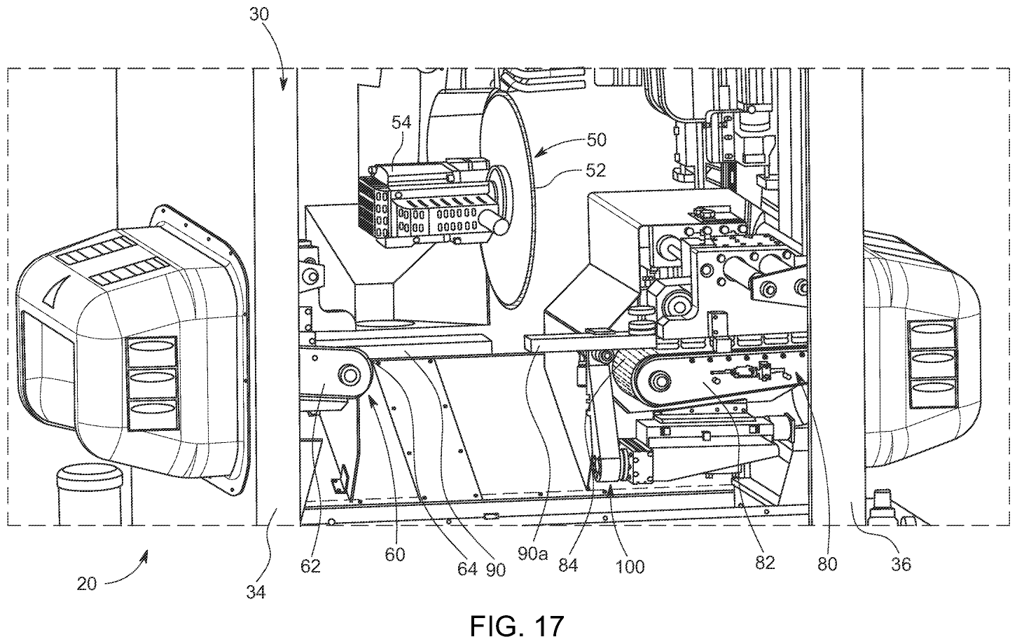

FIGS. 1 to 17 illustrate a lumber board cutting apparatus of one example embodiment of the present disclosure, and that is generally indicated by numeral 20 and sometimes referred to herein as the “apparatus” for brevity. FIGS. 1 to 17 show selected components of the apparatus 20. Various other components of the apparatus 20 that are not discussed herein will be readily understood by those skilled in the art or are not otherwise relevant to the present disclosure.

As best shown in FIGS. 1 and 11 to 17, the illustrated example lumber board cutting apparatus 20 generally includes: (1) a housing 30; (2) a lumber board cutter 50; (3) an infeed drive 60; (4) an outfeed drive 80; and (5) a lumber board gripper 100.

Although not shown, the lumber board cutting apparatus 20 includes an operator interface (not shown) and a controller (not shown). In various embodiments, the operator interface is configured to receive inputs from an operator and to output information to the operator. In various embodiments, the operator interface includes one or more input devices (not shown) configured to receive inputs from the operator. In various embodiments, the one or more input devices include one or more buttons such as hard or soft keys (not shown), one or more switches (not shown), and/or a touch panel (not shown). In various embodiments, the operator interface includes a display device (not shown) configured to display information to the operator, such as information about the status of the lumber board cutting processes, or the settings of the apparatus 20 (such as whether or not the lumber board gripper 100 is being or will be employed for each lumber board cut by the apparatus 20). In various embodiments, the operator interface can include other output devices (not shown) instead of or in addition to the display device, such as one or more speakers (not shown) and/or one or more lights (not shown). In various embodiments, the operator interface is formed as part of the apparatus 20 and is, for instance, mounted to the housing 30. In other embodiments, the operator interface is remote from the housing 30. In various embodiments, the controller includes a processing device (not shown) communicatively connected to a memory device (not shown). In various embodiments, the processing device can include any suitable processing device such as, but not limited to, a general-purpose processor, a special-purpose processor, a digital-signal processor, one or more microprocessors, one or more microprocessors in association with a digital-signal processor core, one or more application-specific integrated circuits, one or more field-programmable gate array circuits, one or more integrated circuits, and/or a state machine. In various embodiments, the memory device can include any suitable memory device such as, but not limited to, read-only memory, random-access memory, one or more digital registers, cache memory, one or more semiconductor memory devices, magnetic media such as integrated hard disks and/or removable memory, magneto-optical media, and/or optical media. In various embodiments, the memory device stores instructions executable by the processing device to control operation of the apparatus 20 (such as to carry out the lumber board cutting processes described herein including the gripping processes for the lumber boards and the operation of the lumber board gripper 100 such as described herein).

Turning back to the drawings, the example illustrated housing 30 includes: (1) a base 32; (2) an infeed side wall 34 connected to and extending upwardly from the base 32; (3) an outfeed side wall 36 connected to and extending upwardly from the base 32; (4) a rear wall 38 connected to and extending upwardly from the base 32; (5) a top wall 40 connected to and extending above the side walls 34 and 36 and the rear wall 38; and (6) a plurality of interior components (not labeled or described herein for brevity). It should be appreciated that the housing 30 can also include a front wall (not shown) connected to and extending from the base 32 or one of the side walls 34 and 36 (and in certain embodiments connected to and supporting the top wall 40). The front wall is not shown in the figures to enable a view into the interior area of the housing 30. In various embodiments, the front wall or one or more of the other walls can include one or more see through windows to enable an operator to see into the interior area of the housing 30. In various embodiments, the front wall or one or more of the other walls is openable and thus provides an access door for enabling access to the interior area of the housing 30. The housing 30 supports the lumber board cutter 50, the infeed drive 60, the outfeed drive 80, and the lumber board gripper 100. It should be appreciated that the housing 30 can be otherwise suitably configured, shaped, sized, supported, and/or positioned in accordance with the present disclosure.

The example illustrated lumber board cutter 50 includes a replaceable saw blade 52 rotatably supported by a saw blade mover 54 that is supported by the housing 30. The lumber board cutter 50 is controlled by the controller and is configured to cause the saw blade 52 to cut lumber boards into desired lengths as the lumber boards are fed by the infeed drive 60 into the interior area of the housing 30. In this example illustrated embodiment, the apparatus 20 is configured to receive and cut single lumber boards sequentially. In other embodiments, the apparatus of the present disclosure can be configured to cut multiple lumbers boards (such as stacked lumbers boards). The saw blade mover 50 includes a motor 54 configured to rotate the saw blade 52. The saw blade mover 50 is configured to position the saw blade 52 at multiple different angles and at multiple different heights to accomplish different cuts of the lumber boards. While the lumber board cutter 50 includes a circular-saw configuration, other types of motorized cutting elements and configurations can be employed in accordance with the present disclosure. It should thus be appreciated that the lumber board cutter 50 can be otherwise suitably configured, shaped, sized, supported, and/or positioned in accordance with the present disclosure.

The infeed drive 60 is configured to receive lumber boards for cutting by the apparatus 20 from outside of the housing 30 and to feed the lumber boards into the interior area of the housing 30 for cutting by the lumber board cutter 50. The infeed drive 60 generally includes: (1) a support frame 62; (2) a conveyor member 64 supported by the frame 62; and (3) a conveyor drive (not shown) supported by the frame 62. The conveyor drive is suitably connected to and engaged with the conveyor member 64. The support frame 62 and the conveyor member 64 are configured to support and move lumber boards into the apparatus 20 and specifically the housing 30 for the lumber boards to be cut. It should be appreciated that the infeed drive 60 can be otherwise suitably configured, shaped, sized, supported, and/or positioned in accordance with the present disclosure.

The outfeed drive 80 is configured to receive lumber boards in the interior area of the housing 30 that are to be cut and/or after they have been cut by the apparatus 20 (depending on the length of the cut lumber boards), and to feed those cut lumber boards out of the interior area of the housing 30 for further processing and usage. The outfeed drive 80 generally includes: (1) a support frame 82; (2) a conveyor member 84 supported by the frame 82; and (3) a conveyor drive (not shown) supported by the frame 82. The conveyor drive (not shown) is connected to and engaged with the conveyor member 84. The support frame 82 and the conveyor member 84 are configured to support and move cut lengths of lumber boards out of the apparatus 20 and specifically the housing 30 after each cut length of lumber board has been cut. It should be appreciated that the outfeed drive 80 can be otherwise suitably configured, shaped, sized, supported, and/or positioned in accordance with the present disclosure.

The lumber board gripper 100 generally includes: (1) a mounting bracket 110; (2) a linear slide 150 connected to the mounting bracket 110; (3) a movable gripper arm support 200 connected to the linear slide 150; (4) a gripper arm 250 pivotally connected to movable gripper arm support 200; (5) a lumber board mover 300 connected to the gripper arm 250; and (6) a lumber board clamper 350 connected to the gripper arm 250. The lumber board gripper 100 is sometimes referred to herein as the gripper 100 for brevity. The gripper 100 is generally configured to: (a) selectively engage and grip a section of a lumber board, to position and hold that section of lumber board before the lumber board is cut; (b) hold the cut length of the lumber board after it is cut; (c) move the cut length of lumber board to the outfeed drive 80; and (d) release the cut length of lumber board onto the outfeed drive 80.

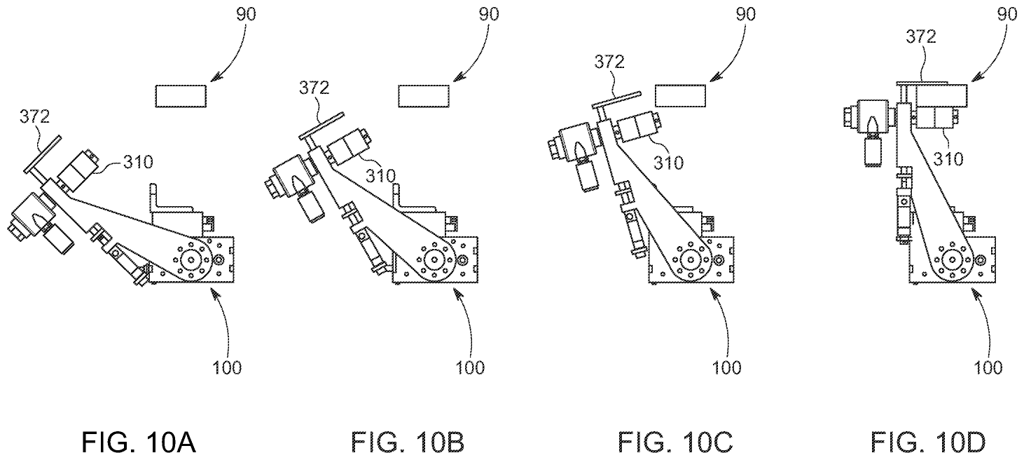

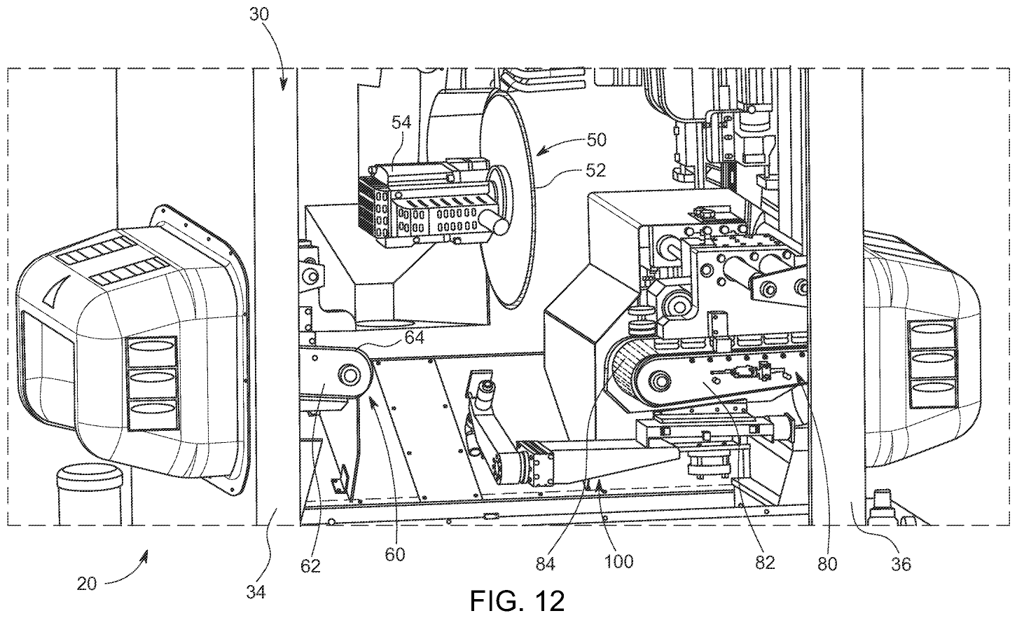

The gripper arm 250 is movable and specifically pivotable about a first axis of rotation from a non-gripping position (shown in FIGS. 1, 2, 3, 4, 5, 6, 7, 8, 10A, 11, and 12) to a gripping position (shown in FIGS. 10D, 13, 14, 15, 16, and 17). In the non-gripping position, the lumber board gripper 100 is positioned out of the way of and thus positioned to not engage or grip the lumber boards being fed though and cut by the apparatus 20. In the gripping position, the gripper arm 250 is positioned such that the lumber board gripper 100 can engage and grip each lumber board being fed through and cut by the apparatus 20. The gripper arm 250 is also movable along the first axis of rotation: (a) in a first direction toward the saw blade 52 of the lumber board cutter 50 to a series of partially extended positions (not shown) and to a fully extended position (shown in FIGS. 12, 13, and 14); (b) in a second direction away from the saw blade 52 of the lumber board cutter 50 and to a fully retracted position (shown in FIGS. 1, 2, 3, 4, 5, 6, 7, 8, 11, 15, 16, and 17); (c) in the first direction away from the outfeed drive 80 to the series of partially extended positions (not shown) and to the fully extended position; and (d) in the second direction toward the outfeed drive 80 to the fully retracted position. As further described herein the gripper arm 250 is movable in these multiple different positions such that the gripper arm 250 can be out of the way when a relatively long length of lumber board (such as above 22 inches (55.88 cms)) is to be cut from lumber board fed into the apparatus 20. For such longer lengths of lumber board to be cut from lumber board fed into the apparatus 20, the gripper 100 does not need to be used. It should be appreciated that the gripper 100 can be used for such longer lengths of lumber board to be cut from lumber board fed into the apparatus 20. As also further described herein, in various embodiments, the gripper arm 250 is movable into these multiple different positions such that the gripper arm 250 can be employed when a relatively short length of lumber board (such as equal to or greater than 6 inches (15.24 cms)) and less than 22 inches is to be cut from a lumber board fed into the apparatus 20. In such instances, the gripper arm 250 can move to one of the partially extended positions or the fully extended position to engage and grip a front section of the lumber board fed into the interior of the housing 30 by the infeed drive 60 prior to the short length of lumber board being cut from that lumber board, to move such short length of lumber board to the outfeed drive 80 after the short length of lumber board has been cut by the lumber board cutter 50, as further described below.

More specifically, the mounting bracket 110 includes a mounting member 120 connected to a linear slide support member 130. The mounting member 120 extends in a generally upright manner, defines a plurality of fastener mounting openings (not labeled), and is configured to be mounted to a bracket of the frame 82 of the outfeed drive 80. In this embodiment, the outfeed drive 80 thus supports the gripper 100 and certain parts of the gripper 100 are positioned below the outfeed drive 80. It should be appreciated that the mounting bracket 110 can be otherwise suitably configured, shaped, sized, supported, and/or positioned in accordance with the present disclosure.

The linear slide 150 includes an upper mounting bracket 160 connected to the linear slide support member 130 of the mounting bracket 110. More specifically, the upper mounting bracket 160 includes a top wall 166 connected to the linear slide support member 130 of the mounting bracket 110, a first side wall 162 connected to and extending downwardly from a first side of the top wall 166, a second side wall 164 connected to and extending downwardly from a second side of the top wall 166, a first end wall 168 connected to and extending downwardly from a first end of the top wall 166, and a second end wall 170 connected to and extending downwardly from a second end of the top wall 166. The first side wall 162 is spaced apart from the second side wall 164, and the first end wall 168 is spaced apart from the second end wall 170. The interior surfaces (not labeled) of the top wall 166, the first side wall 162, the second side wall 164, the first end wall 168, and the second end wall 170 define an interior carriage movement area (not labeled).

The linear slide 150 further includes: (a) a carriage actuator 172 supported by and extending between the first end wall 168 and the second end wall 170; (b) a motor 190 connected to the first end wall 168 and coupled to the carriage actuator 172; and (c) a movable carriage 176 supported by the carriage actuator 172. The motor 190 is configured to, under control of the controller, cause the carriage actuator 172 to move the carriage 176 back and forth in the interior carriage movement area. Movement of the carriage 176 in the interior carriage movement area causes the gripper arm 250 to move to the fully extended position, the partially extended positions, and the retracted position (and thus farther away from or closer to the outfeed drive 80). The linear slide 150 includes: (a) a carriage flag 178 connected to and supported by the carriage 176; (b) a first sensor 180 connected to the side wall 162 at a first position adjacent to the first end wall 168; and (c) a second sensor 182 connected to the side wall 162 at a second position adjacent to the second end wall 170. These first and second positions are spaced apart. The flag 178, the first sensor 180, and the second sensor 182 operate with the controller to determine or verify when the carriage 176 and thus when the gripper arm 250 are in the fully extended position and the fully retracted position. The linear slide 150 is controlled by the controller of the apparatus 20 to partly control the extension and retraction of the gripper arm 250. It should be appreciated that the linear slide 150 can be otherwise suitably configured, shaped, sized, supported, and/or positioned in accordance with the present disclosure.

The movable gripper arm support 200 includes a mounting bracket 212 connected to the carriage 176 of the linear slide 150. The mounting bracket 212 includes a top wall 210 that is connected to the carriage 176 by suitable fasteners (not shown), a first side wall 212 connected to and extending downwardly from the top wall 210, a second side wall 214 connected to and extending downwardly from the top wall 210, and an end wall 216 connected to and extending downwardly from the top wall 210 and connected to the first side wall 212 and the second side wall 214. The movable gripper arm support 200 also includes a gripper arm pivot 220 attached to the end wall 216 of the mounting bracket 212. The gripper arm pivot 220 includes components (not shown) that cause the gripper arm 250 that is attached to the gripper arm pivot 220 to pivot: (1) from the non-gripping position to the gripping position under the control of the controller of the apparatus 20, and (2) from the gripping position to the non-gripping position under the control of the controller of the apparatus 20. In other words, the gripper arm pivot 220 controls the pivoting of the gripper arm 250 under control of the controller. In this example embodiment, the gripper arm pivot 220 includes an adjustable angle rotary cylinder. It should be appreciated that the movable gripper arm support 200 can be otherwise suitably configured, shaped, sized, supported, and/or positioned in accordance with the present disclosure.

The gripper arm 250 includes a pivot attachment section 255, a lower section 260, and an upper section 270. The pivot attachment section 255 is connected to the gripper arm pivot 220 and extends outwardly from the movable gripper arm support 200 and specifically from the gripper arm pivot 220. The lower section 260 is connected to the pivot attachment section 255 and extends transversely from the pivot attachment section 255. The upper section 270 is connected and extends from the lower section 260. The gripper arm 250 and specifically the upper section 270 is configured to support the lumber board mover 300 and the lumber board clamper 350. As mentioned above, the gripper arm 250 is pivotable about a first axis of rotation from the non-gripping position (shown in FIGS. 1, 2, 3, 4, 5, 6, 7, 8, 10A, 11, and 12) to the gripping position (shown in FIGS. 10D, 13, 14, 15, 16, and 17). In the non-gripping position, the gripper arm 250 is positioned such that the gripper arm 250, the lumber board mover 300, and the lumber board clamper 350 are out of the way of any lumber boards being fed though the apparatus 20. In the gripping position, the gripper arm 250 is positioned such that the lumber board mover 300 and the lumber board clamper 350 can engage and grip a lumber board as the lumber board is fed into the apparatus 20 by the infeed drive and to a cutting position for that lumber board. As also mentioned above, the gripper arm 250 is also movable along the first axis in the first direction toward the saw blade 52 of the lumber board cutter 50 and to the fully extended position (shown in FIGS. 12, 13, and 14) and in the second direction away from the saw blade 52 of the lumber board cutter 50 and to the fully retracted position (shown in FIGS. 1, 2, 3, 4, 5, 6, 7, 8, 11, 15, 16, and 17). This enables the gripper 100 and specifically the lumber board mover 300 and the lumber board clamper 350 to engage and grip a lumber board as the lumber board is fed into the apparatus 20 at any one of a plurality of different distances from the saw blade 52. This also enables the gripper 100 and specifically the gripper arm 250, the lumber board mover 300, and the lumber board clamper 350 to move the lumber board before it is cut and to move the cut length of the lumber board after it is cut by the saw blade 52. It should be appreciated that the gripper arm 250 can be otherwise suitably configured, shaped, sized, supported, and/or positioned in accordance with the present disclosure.

The lumber board clamper 350 includes: (1) a mounting base 360 connected to the upper section 270 of the gripper arm 250; (2) a clamping arm 370 movably coupled to and supported by the mounting base 360; and (3) a clamping arm actuator 380 connected to and supported by the mounting base 360 and coupled to the clamping arm 370. Since the mounting base 360 is connected to the upper section 270 of the gripper arm 250, the clamping arm 370 is thus movably coupled to and supported by the gripper arm 250, and the clamping arm actuator 380 is supported by gripper arm 250. It should be further be appreciated that these components thus move when the gripper arm 250 moves. The clamping arm 370 includes a transversely extending clamping hand 372 and clamping hand supports 374A and 374B connected to and supporting the clamping hand 372. The clamping arm actuator 380 includes a cylinder 382 (actuated by a solenoid valve that is not shown) and a moveable shaft 384 extendable from the cylinder 382. The shaft 384 is connected to the clamping hand supports 374A and 374B inside of the mounting base 360 such that when the shaft 384 moves, the clamping hand supports 374A and 374B and the clamping hand 372 move in the same direction. In other words, the clamping arm 370 and specifically the clamping hand supports 374A and 374B are coupled to the moveable shaft 384 of the clamping arm actuator 380 such that the clamping hand supports 374A and 374B are moveable further into and out of the mounting base 360 and such that the clamping hand 372 is movable toward and away from the mounting base 360 and toward and away from the drive roller 310 of the lumber board mover 300. The clamping arm actuator 380 is controlled by the controller of the apparatus 20 such that when the gripper 100 is employed to grip a section of a lumber board, the controller can cause the clamping arm actuator 380 to move the clamping hand supports 374A and 374B to cause the clamping hand 372 to move to engage a top surface of the lumber board and co-act with the lumber boarder mover 300 to grip the lumber board. It should be appreciated that the lumber board clamper 350 can be otherwise suitably configured, shaped, sized, supported, and/or positioned in accordance with the present disclosure.

The lumber board mover 300 includes: (1) a drive roller 310 rotatably connected to the mounting base 360; (2) a drive roller actuator 330; and (3) suitable connection members 320 that connect and couple the drive roller 310 to the mounting base 360 and the drive roller actuator 330. The drive roller 310 is thus also rotatably connected to and supported by the gripper arm 250 and the drive roller actuator 330 is also connected to and supported by the gripper arm 250. It should be further be appreciated that these components thus move when the gripper arm 250 moves. The drive roller actuator 330 in this example embodiment includes an air motor, but can be another suitable drive motor in accordance with the present disclosure. The drive roller 310 is rotatable about an axis of rotation that is parallel to the plane in which the clamping hand 372 extends. The drive roller actuator 330 is controlled by the controller of the apparatus 20 such that when the gripper 100 is employed to grip a section of a lumber board, the controller can cause the drive roller actuator 330 to rotate the drive roller 310 to engage co-act with the lumber boarder mover 300 to grip the lumber board and to move to the lumber board. It should be appreciated that the lumber board mover 300 can be otherwise suitably configured, shaped, sized, supported, and/or positioned in accordance with the present disclosure.

When a lumber board to be cut is fed into the apparatus 20 and will not be gripped by the gripper 100, the controller causes the gripper arm 250 to be in the non-gripping position such as shown in FIGS. 1, 10A, and 11.

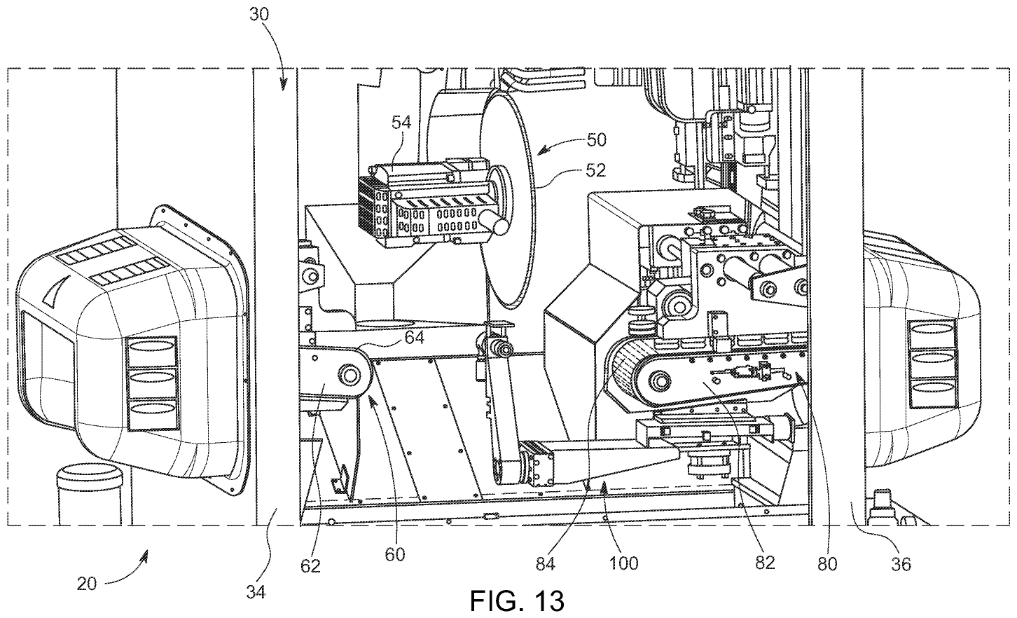

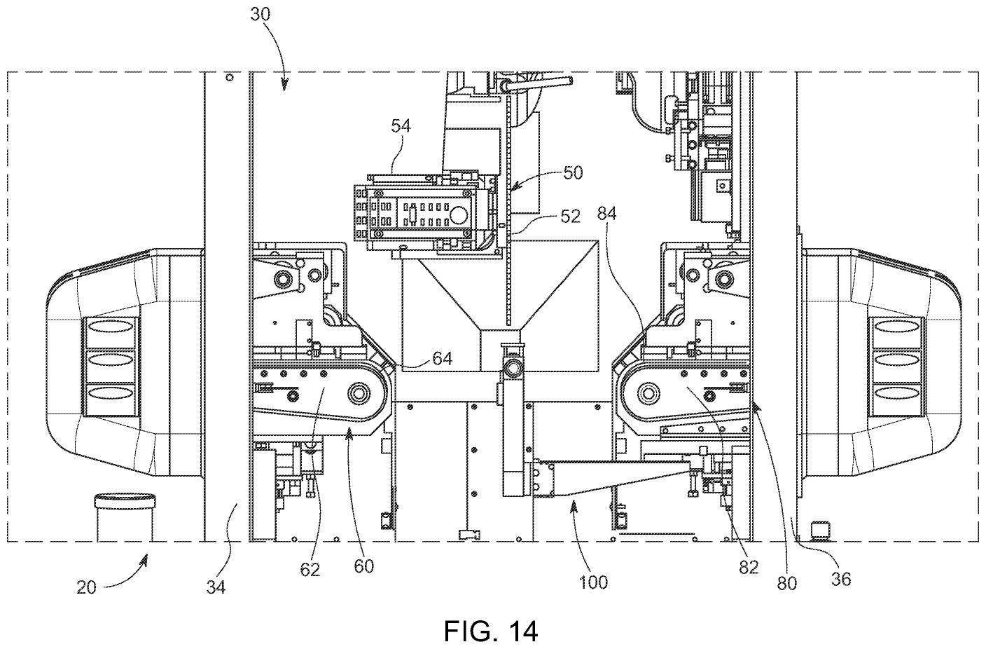

When a lumber board to be cut is fed into the apparatus 20 and will be gripped by the gripper 100, the controller causes the gripper arm 250 to move to an extended position such as the fully extended position that is shown in FIG. 12, and then to the extended position and gripping position such as shown in FIGS. 13 and 14. It should be appreciated that the controller can alternatively cause the gripper arm 250 to move the gripping position and then to the fully extended position. One example process for gripping the lumber board is illustrated in FIGS. 10A, 10B, 10C, and 10D where the lumber board to be gripped is already in a position to be gripped and the gripper arm 250 moves into the position for gripping of the lumber board. In these positions, the gripper arm 250 is thus located such that the gripper 100 can engage and grip a section of a lumber board after that lumber board is fed by the infeed drive 80. It should be appreciated that the controller can, if needed, cause the clamping hand 372 to move upwardly away from the drive roller 310 to provide clearance between the clamping hand 372 and the driver roller 310 for receipt of the lumber board and then the controller can cause the clamping hand 372 to move downwardly toward the drive roller 310 to cause the clamping hand 372 and the drive roller 310 to engage and securely grip the section of lumber board. Another example process for gripping the lumber board includes the controller cause the gripper arm 250 to move into one of the extended positions such as the fully extend position and to the gripping position such that the clamping hand 372 and the drive roller 310 are located to receive, engage, and grip a section of a lumber board that is then feed into the apparatus 10 (or further feed into the apparatus 10). Specifically, a section of the lumber board can move from the infeed drive 80 into the space between the clamping hand 372 and the drive roller 310, and the controller can cause the clamping hand 372 to move downwardly to cause the clamping hand 372 and the drive roller 310 to engage and grip the section of lumber board.

After gripper 100 engages and grips the section of lumber board, the controller can cause the gripper arm 250 to move in the second direction toward the outfeed drive 80 and out of the way of the saw blade 52. This movement can be used to position the lumber board in a desired position for cutting. It should be appreciated that the controller can alternatively cause the gripper arm 250 to be in an extended position—but not the fully extended position—when the gripper 100 engage and grips the section of the lumber board such that the gripper arm 250 does not need to be moved after the gripping process and before the cutting process.

The gripper 100, and specifically the clamping hand 372 and the drive roller 310 engage and grip the section of lumber board during the cutting process and thus holds the portion of the lumber board that will be cut from the rest of the lumber board during such cutting process. Thus, the gripper 100 can hold relatively short length of lumber board to be cut and does not allow those cut short lengths to fall downwardly after they have been cut.

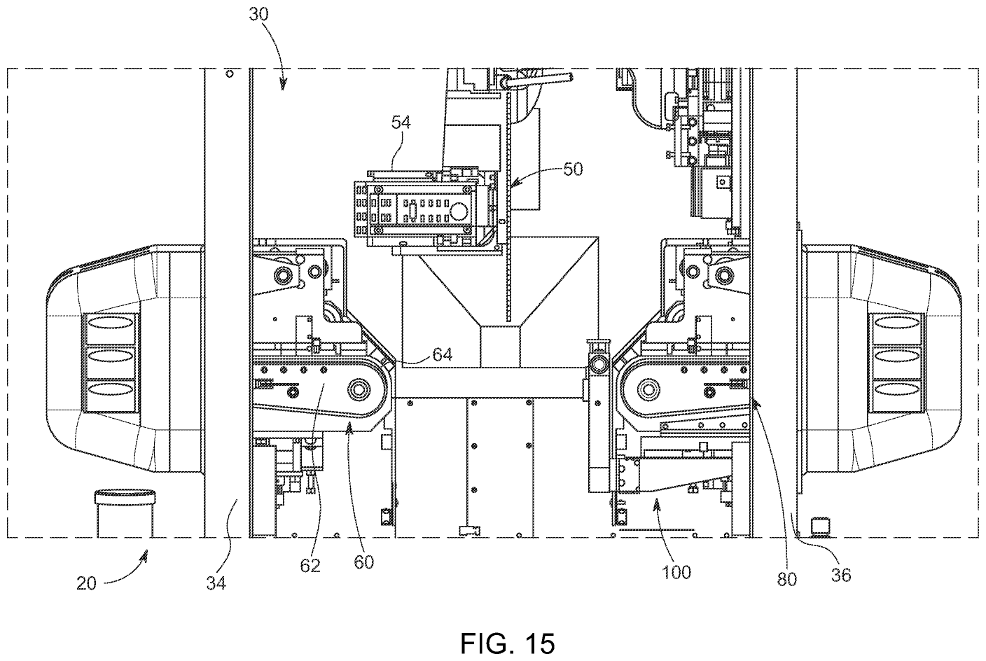

After the length of lumber board is cut from the rest of the lumber board, the controller cause the gripper arm to move to the fully retracted position such as shown in FIGS. 15, 16, and 17 to position or further position the cut length on lumber board on the outfeed drive 80.

It should be appreciated that the controller can precisely control the movement of the gripper arm 250 in both directions and can precisely control the rotation of the drive roller 310 to move the lumber board and to transfer the cut lumber board to the outfeed drive 80.

It should be appreciated that the apparatus 20 can include one or more sensors (not shown) or other suitable mechanisms (not shown) apparatus to determine the dimensions and positions of each lumber board processed by the apparatus 20. It should be appreciated from the above that in various embodiments the apparatus 20 can be set up for processing lumber boards having different dimensions and/or orientations. For example, if the apparatus 20 is set up to process lumber with different dimensions and orientation such as 4×2, and/or 3×2.

Various changes and modifications to the present embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A lumber board cutting apparatus comprising:
a housing;
an infeed drive;
an outfeed drive;
a lumber board cutter; and
a lumber board gripper including:
a gripper arm,
a lumber board mover connected to the gripper arm, and
a lumber board clamper connected to the gripper arm.

2. The lumber board cutting apparatus of claim 1, wherein the gripper arm is movable toward and away from the outfeed drive.

3. The lumber board cutting apparatus of claim 2, wherein the lumber board gripper includes a linear slide positioned under the outfeed drive.

4. The lumber board cutting apparatus of claim 1, wherein the lumber board gripper includes a mounting bracket, a linear slide connected to the mounting bracket, a movable gripper arm support connected to the linear slide, and wherein the gripper arm is pivotally connected to the movable gripper arm support.

5. The lumber board cutting apparatus of claim 1, wherein the gripper arm is pivotally moveable relative to the outfeed drive.

6. The lumber board cutting apparatus of claim 5, wherein the lumber board gripper includes a mounting bracket and a gripper arm support, wherein the gripper arm is pivotally connected to the gripper arm support.

7. The lumber board cutting apparatus of claim 1, wherein the gripper arm is movable toward and away from the outfeed drive, wherein gripper arm is pivotally moveable relative to the outfeed drive, and wherein the gripper is configured to selectively engage and grip a section of a lumber board before the lumber board is cut, hold a cut length of the lumber board after the cut length of lumber board is cut, move the cut length of lumber board to the outfeed drive, and release the cut length of lumber board onto the outfeed drive.

8. The lumber board cutting apparatus of claim 1, wherein the lumber board clamper includes a mounting base connected to the gripper arm, a clamping arm movably coupled to and supported by the mounting base, and a clamping arm actuator supported by the mounting base and coupled to the clamping arm.

9. The lumber board cutting apparatus of claim 8, wherein the clamping arm includes a transversely extending clamping hand and clamping hand supports connected to and supporting the clamping hand.

10. The lumber board cutting apparatus of claim 1, wherein the lumber board mover includes a drive roller rotatably supported by the gripper arm and a drive roller actuator supported by the gripper arm.

11. A lumber board cutting apparatus comprising:
a housing;
an infeed drive;
an outfeed drive;
a lumber board cutter; and
a lumber board gripper including:
a gripper arm movable toward and away from the outfeed drive and pivotally moveable relative to the outfeed drive,
a lumber board mover connected to the gripper arm, the lumber board mover including a drive roller rotatably supported by the gripper arm and a drive roller actuator supported by the gripper arm, and
a lumber board clamper connected to the gripper arm, the lumber board clamper including a clamping arm movably supported by the gripper arm, and a clamping arm actuator supported by the gripping arm and coupled to the clamping arm.

12. The lumber board cutting apparatus of claim 11, wherein the gripper is configured to selectively engage and grip a section of a lumber board before the lumber board is cut, hold a cut length of the lumber board after the cut length of lumber board is cut, move the cut length of lumber board to the outfeed drive, and release the cut length of lumber board onto the outfeed drive.

13. The lumber board cutting apparatus of claim 11, wherein the clamping arm includes a transversely extending clamping hand and clamping hand supports connected to and supporting the clamping hand.

14. The lumber board cutting apparatus of claim 11, wherein the lumber board gripper includes a mounting bracket, a linear slide connected to the mounting bracket, a movable gripper arm support connected to the linear slide, and wherein the gripper arm is pivotally connected to movable gripper arm support.

15. The lumber board cutting apparatus of claim 11, wherein the gripper arm is pivotable about a first axis of rotation from a non-gripping position to a gripping position.

16. The lumber board cutting apparatus of claim 15, wherein when the gripper arm is in the non-gripping position, the gripper arm is positioned to not grip any lumber boards fed though the housing, and when in the gripper arm is in the gripping position, the gripper arm is positioned such that the gripper arm can grip each lumber board fed through the housing.

17. The lumber board cutting apparatus of claim 11, wherein the gripper arm is movable along the first axis of rotation: (a) in a first direction toward the lumber board cutter to a series of partially extended positions and to a fully extended position; and (b) in a second direction away from the lumber board cutter to a fully retracted position.

18. The lumber board cutting apparatus of claim 11, wherein the gripper arm is movable along a first axis: (a) in a first direction toward the lumber board cutter to a series of partially extended positions and to a fully extended position; and (b) in a second direction away from the lumber board cutter to a fully retracted position.
